(19) United States
(12) Patent Application Publication
(10) Pub. No.: US 2020/0394611 A1
(43) Pub. Date: Dec. 17, 2020

(54) INFORMATION PROCESSING DEVICE, AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Kiichiro ARIKAWA, Kanagawa (JP)

(73) Assignee: FUJI XEROX CO., LTD., Tokyo (JP)

(21) Appl. No.: 16/734,387

(22) Filed: Jan. 5, 2020

(30) Foreign Application Priority Data
Jun. 11, 2019 (JP) 2019-108480

(51) Int. Cl. G06Q 10/10; G06F 16/954

(52) U.S. Cl. CPC G06Q 10/10; G06F 16/954

(57) ABSTRACT

An information processing device includes a change unit that changes details of content browsed by a browsing user according to information on an individual other than the browsing user of the content.

### CROSS-REFERENCE TO RELATED APPLICATIONS

This application is based on and claims priority under 35 USC 119 from Japanese Patent Application No. 2019-108480 filed on Jun. 11, 2019.

### BACKGROUND

### (i) Technical Field

The present disclosure relates to an information processing device, and a non-transitory computer readable medium storing an information processing program.

### (ii) Related Art

In Japanese Unexamined Patent Application Publication No. 2019-075145, it is aimed to provide an information processing device, a control method, and a non-transitory computer readable medium storing a program that are capable of increasing the cost effectiveness of advertisement by delivering advertisements according to a step in a process until an event occurs, the information processing device including a content specifier that specifies a content; an event specifier that specifies an event; a calculation part that calculates a rate of contribution of the content specified by the content specifier to an occurrence of the event specified by the event specifier, based on a content browsing history of each of multiple users and an event occurrence history of each of the multiple users; an association part that associates each content with a corresponding step of a process to the event based on the rate of contribution, calculated by the calculation part, of each of multiple pieces of content to the occurrence of the event; and a distribution setting part that makes settings so that advertisement information according to a step is delivered to the content associated with the step.

### SUMMARY

When the details of content are changed and presented, with a configuration in which the details of content are changed according to attribute information which simply indicates attributes of a browsing user, change may be made only from the point of view of the browsing user. Thus, it is not possible to change the details of the content from the point of view of an individual other than the browsing user. Aspects of non-limiting embodiments of the present disclosure relate to an information processing device and a non-transitory computer readable medium storing an information processing program that, when the details of content are changed and presented, are capable of changing the details of the content from the point of view of an individual other than a browsing user, as compared with the case where the details of content are changed according to attribute information which simply indicates attributes of the browsing user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a change unit that changes details of content browsed by a browsing user according to information on an individual other than the browsing user of the content.

### BRIEF DESCRIPTION OF THE DRAWINGS

Exemplary embodiment of the present disclosure will be described in detail based on the following figures, wherein:

FIG. 1 is a conceptual module configuration diagram of a configuration example of an exemplary embodiment;

FIG. 2 is an explanatory diagram illustrating a system configuration example utilizing the exemplary embodiment;

FIG. 3 is a flowchart illustrating an example of processing according to the exemplary embodiment;

FIGS. 4A and 4B are explanatory tables illustrating data structure examples of a user attribute (work) table, and a user attribute (SNS) table;

FIG. 5 is an explanatory table illustrating a data structure example of a log information table;

FIG. 6 is an explanatory table illustrating a data structure example of a keyword table;

FIG. 7 is a flowchart illustrating an example of processing according to the exemplary embodiment;

FIG. 8 is a flowchart illustrating an example of processing according to the exemplary embodiment;

FIG. 9 is a flowchart illustrating an example of processing according to the exemplary embodiment;

FIGS. 10A and 10B are explanatory tables illustrating data structure examples of the user attribute (work) table, and the user attribute (SNS) table;

FIG. 11 is an explanatory table illustrating a data structure example of the keyword table;

FIGS. 12A and 12B are explanatory screens illustrating an example of processing according to the exemplary embodiment;

FIGS. 13A and 13B are explanatory screens illustrating an example of processing according to the exemplary embodiment; and

FIG. 14 is a block diagram illustrating a hardware configuration example of a computer which implements the exemplary embodiment.

### DETAILED DESCRIPTION

Hereinafter an example of an exemplary embodiment which implements the disclosure will be described with reference to the drawings.

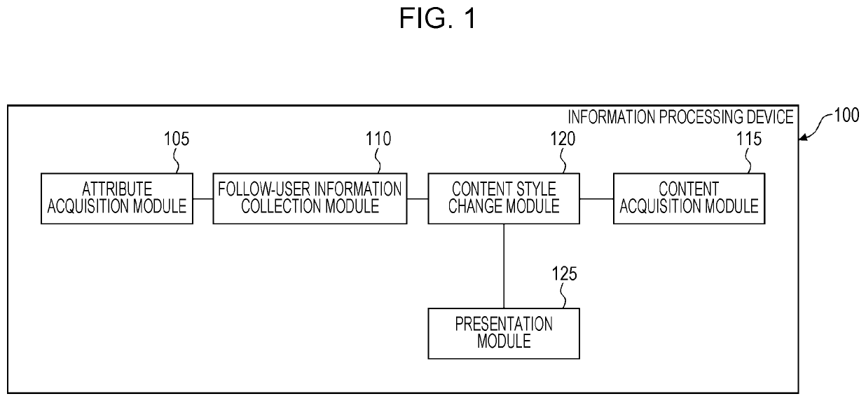

FIG. 1 illustrates a conceptual module configuration diagram of a configuration example of the exemplary embodiment.

It is to be noted that in general, the module refers to a logically separable component, such as software (the interpretation of the “software” includes a computer program) and hardware. Therefore, the module in the exemplary embodiment refers not only to a module in a computer program, but also to a module in a hardware configuration. Thus, the exemplary embodiment also provides explanation for a computer program for functioning as those modules (for instance, a program for causing a computer to execute each step, a program for causing a computer to function as each unit, and a program for causing a computer to implement each function), a system, and a method. However, for the sake of convenience of explanation, “stores”, “causes to store”, and words equivalent to these are used, and when the exemplary embodiment is a computer program, these words mean that “stores in a storage device” or “perform control to causes a storage device to store”. Although each module may have one-to-one correspondence with each function, in the implementation, one module may be configurated by one program, multiple modules may be configurated by one program, and conversely, one module may be configurated by multiple programs. Also, multiple modules may be executed by one computer, or one module may be executed by multiple computers in a distributed or parallel environment. It is to be noted that one module may include other modules. Hereinafter “connection” is used for logical connection (for instance, data exchange, instructions, reference relationship between data, login) in addition to physical connection. “Predetermined” means determined before target processing, and not only it is before processing according to the exemplary embodiment is started, but also it is after processing according to the exemplary embodiment is started, if it is before target processing, “predetermined” is also used to mean determined according to the situation and state then, or according to the previous situation and state. When multiple “predetermined values” are present, the values may be different, or two or more values (quite logically, two or more values include all the values) may be the same. Also, a description such as “when A is satisfied, B is performed” is used to mean that “it is determined whether or not A is satisfied, and when A is determined to be satisfied, B is performed”, provided that the case where determination as to whether or not A is satisfied is unnecessary is excluded. Also, when things are listed like “A, B, C”, listing of examples is provided unless otherwise is stated, and the case where only one of them (for instance, only A) is selected is included.

Also, the system or the device includes the case where it is implemented by one computer, hardware, or device in addition to the case where it is configurated by connecting multiple computers, hardware, devices via a communication unit such as a network (“network” includes one-to-one correspondence communication connection). The “device” and the “system” are used as synonymous terms. Needless to say, the “system” does not include a social “structure” (in other words, a social system) which is an artificial arrangement.

Also, when processing according to a module or multiple pieces of processing are performed in a module, for each processing, target information is read from a storage device, and after the processing is performed, a processing result is written to the storage device. Thus, a description of reading from the storage device before the processing and writing to the storage device after the processing may be omitted. It is to be noted that the storage device herein may include a hard disk drive, a RAM (abbreviation of Random Access Memory), an external storage medium, a storage device via a communication line, and a register in a CPU (abbreviation of Central Processing Unit).

An information processing device 100 in the exemplary embodiment has a function of presenting content to a browsing user. As illustrated in the example of FIG. 1, the information processing device 100 has an attribute acquisition module 105, a follow-user information collection module 110, a content acquisition module 115, a content style change module 120, and a presentation module 125. The information processing device 100 changes the content presented to a user according to the preference of the user, for instance.

The attribute acquisition module 105 is connected to the follow-user information collection module 110. The attribute acquisition module 105 acquires attribute information which indicates attributes of a browsing user. The “attribute information” may be, for instance, attribute information managed in association with a user ID (abbreviation of IDentification) in an organization to which the browsing user belongs, or information in a profile in a SNS (abbreviation of Social Networking Service) in which the browsing user participates.

In addition, as the attribute information, the attribute acquisition module 105 may acquire information on an individual followed by the browsing user.

In addition, as the attribute information, the attribute acquisition module 105 may acquire information which indicates an organization to which the browsing user belongs.

The follow-user information collection module 110 is connected to the attribute acquisition module 105, and the content style change module 120. The follow-user information collection module 110 collects information on an individual other than the browsing user, the information being generated using the attribute information acquired by the attribute acquisition module 105.

Here, the “information on an individual other than the browsing user” may be information of all or part of the details of the content disclosed by an individual followed by the browsing user, or all or part of the details of the content disclosed in relation to the individual.

The “individual followed” is an individual other than the browsing user in the case where the browsing user has set subscription of the content provided by the individual. For instance, the individual corresponds to a destination user followed in an SNS. In this case, following is to make settings for displaying tweets of the destination user on the time line of the browsing user. The “content disclosed by an individual” corresponds to a message (referred to as tweets in general) posted by the individual, and a comment on a message of another user.

The “content disclosed by an individual” may be content in relation to the individual. Particularly, content expressing the thought and intention of the individual is desired. For instance, the “content disclosed by an individual” may be content created by the individual or may be content cited by the individual.

The “content disclosed in relation to an individual” is not the content disclosed by the individual, but may be the content disclosed by another individual in relation to the individual. For instance, a comment written by another individual on the content disclosed by the individual applies.

Also, when the content is meeting minutes, and the attribute information is information indicating an organization to which the browsing user belongs, the “information on an individual other than the browsing user” may be information indicating an individual in relation to the browsing user in the organization.

Here, the “individual in relation to the browsing user” may be an individual other than the browsing user, who has some relation to the browsing user. For instance, an individual belonging to the same organization as that of the browsing user, and a superior of the browsing user apply. Specifically, a table which stores information (for instance, a user ID applies) which uniquely identifies the browsing user, and information (for instance, an organization ID applies) which uniquely identifies the organization to which the browsing user belongs in association with each other, and a table which stores individuals belonging to the organization and the position of each individual in association with each other may be used.

The content acquisition module 115 is connected to the content style change module 120. The content acquisition module 115 acquires the content presented to a user. For instance, the content acquisition module 115 may acquire content in accordance with a browsing operation which is a request by a user or may acquire content in accordance with predetermined processing. Also, the content is text data, numerical value data, figure data, image data, video data, audio data, or a combination thereof, and refers to an object to be stored, edited, or searched, which can be exchanged as an individual unit between systems or users, and includes objects similar these. For instance, the content includes a document and a file created by a document creation program (so-called word processor software), an image read by an image reading device (such as a scanner), a Web page, and a video. Specifically, the content may be meeting minutes browsed in a business operation, or may be a Web page, such as a news article, browsed based on a personal interest.

The content style change module 120 is connected to the information processing device 100, the content acquisition module 115, and the presentation module 125. The content style change module 120 changes the details of content browsed by the browsing user in accordance with information on an individual other than the browsing user. For instance, the individual other than the browsing user is a person selected using the attribute information which indicates the attributes of the browsing user. Specifically, the content style change module 120 changes the details of the content requested by the browsing user in accordance with information on an individual other than the browsing user, the information being generated using the attribute information which indicates the attributes of the browsing user.

In addition, in the content requested by the browsing user, the content style change module 120 may make a change on a word which is the same as or similar to a word in the content disclosed by the individual.

In addition, the content style change module 120 makes a change on statement part in meeting minutes, the statement being made by an individual having relation to the browsing user.

The presentation module 125 is connected to the content style change module 120. The presentation module 125 presents content to the browsing user, the content having details changed by the content style change module 120.

Here, “presentation” may include reading of the content in addition to display of the content.

The “details of the content” to be changed may be the exact details of the content, or may be a format which is the appearance when the content is presented. The “format of content” includes, for instance, a font (such as a color, a size, an italic type, and a bold type) of characters, an underline, and a space between characters. Also, when characters are read, the “format of content” may be loudness of voice, and intonation.

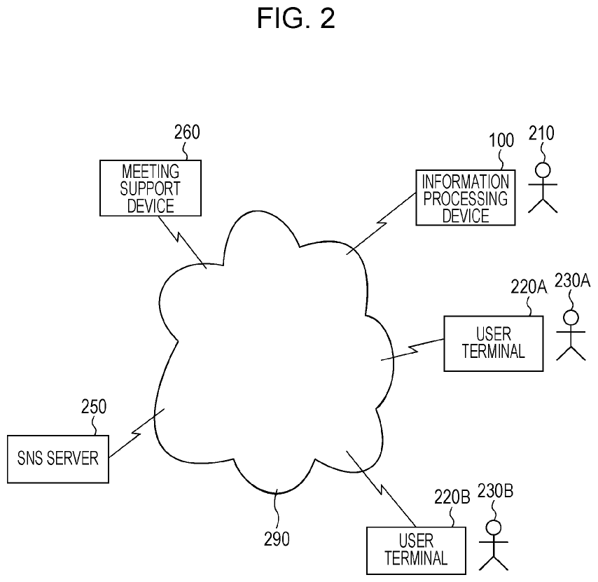

FIG. 2 is an explanatory diagram illustrating a system configuration example utilizing the exemplary embodiment.

The information processing device 100, a user terminal 220A, a user terminal 220B, an SNS server 250, a meeting support device 260 are coupled to each other via a communication line 290. The communication line 290 may be wireless, wired, or a combination thereof, and for instance, may be the Internet, or Intranet as a communication infrastructure. Also, the function of the information processing device 100 may be implemented as a cloud service, and the SNS server 250, and the meeting support device 260 may include the function of the information processing device 100.

The information processing device 100 herein is implemented for instance by a smartphone, and a personal computer, and is utilized by a user 210 which is an example of the browsing user.

For instance, the user 230A is a superior of the user 210 who pays attention to the statements in a meeting, and the comments to a document made by the user 230A.

In such a case, when the user 210 refers to minutes of a meeting attended by the user 230A, the statements of the user 230A, and part interested by are the user 230A are displayed with highlight by the information processing device 100.

For instance, a user 230B is an individual followed by the user 210 in an SNS. In other words, the user 210 is able to constantly check the posts made by the user 230B in the SNS. Specifically, the details posted by the user 230B are displayed as a time line on a home screen of the user 210 in the SNS. In a reverse viewpoint, the user 210 is a follower of the user 230B.

For instance, when the user 210 browses a news article, part of the article, which is likely to attract interest of the user 230B, is displayed with highlight by the information processing device 100.

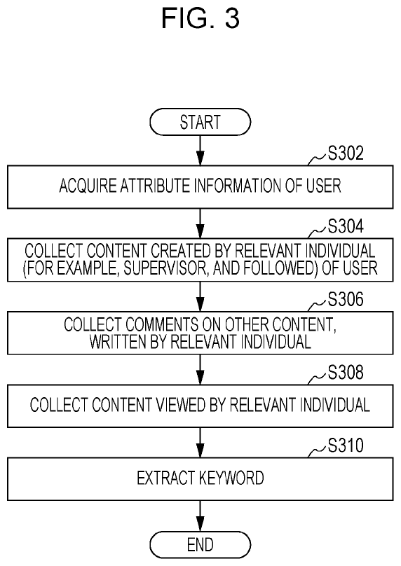

FIG. 3 is a flowchart illustrating an example of processing according to the exemplary embodiment.

In step S302, the attribute acquisition module 105 acquires attributes of the user 210.

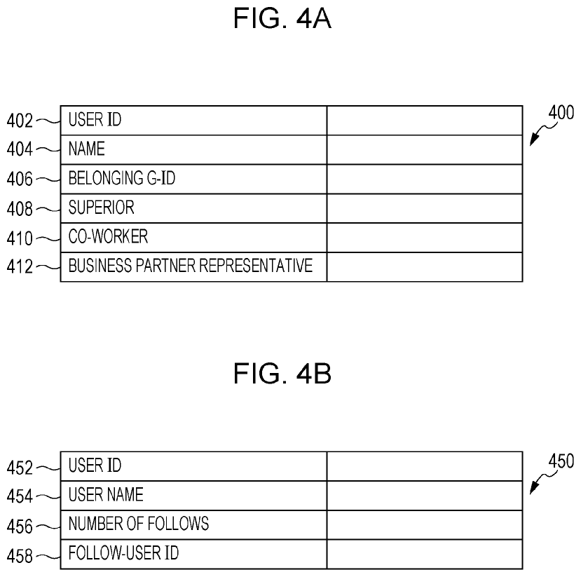

For instance, when the user 210 attempts to browse content at work, the attribute acquisition module 105 acquires a user attribute (work) table 400. Whether browsing is made at work may be determined by whether or not the device utilized by the user 210 is supplied from a company (when the device is supplied by a company, the browsing is determined to be made at work), or by the date and time on which browsing is made by the user 210 (when the date and time is within working hours, the browsing is determined to be made at work). FIG. 4A is an explanatory table illustrating a data structure example of the user attribute (work) table 400. The user attribute (work) table 400 has a user ID column 402, a name column 404, a belonging G-ID column 406, a superior column 408, a co-worker column 410, and a business partner representative column 412. In the exemplary embodiment, the user ID column 402 stores information (specifically, the user ID) which uniquely identifies a user. The name column 404 stores the name of the user. The belonging G-ID column 406 stores the group ID of a group to which the user belongs. The superior column 408 stores the user ID of a superior of the user. The co-worker column 410 stores the user ID of a co-worker of the user. The business partner representative column 412 stores the user ID of a business partner representative.

When the user 210 attempts to browse content based on a personal interest other than work, a user attribute (SNS) table 450 is acquired. FIG. 4B is an explanatory table illustrating a data structure example of the user attribute (SNS) table 450. The user attribute (SNS) table 450 has a user ID column 452, a user name column 454, a number of follows column 456, and a follow-user ID column 458. The user ID column 452 stores a user ID. The user name column 454 stores the user name of the user. The number of follows column 456 stores the number of follows in an SNS followed by the user. The follow-user ID column 458 stores the user ID of another user followed by the user.

In step S304, content created by relevant individual (for instance, a superior, and an individual followed by the user 210) to the user 210 is collected.

In step S306, the comments written by the relevant individual on other content are collected.

In step S308, the content browsed by the relevant individual is collected.

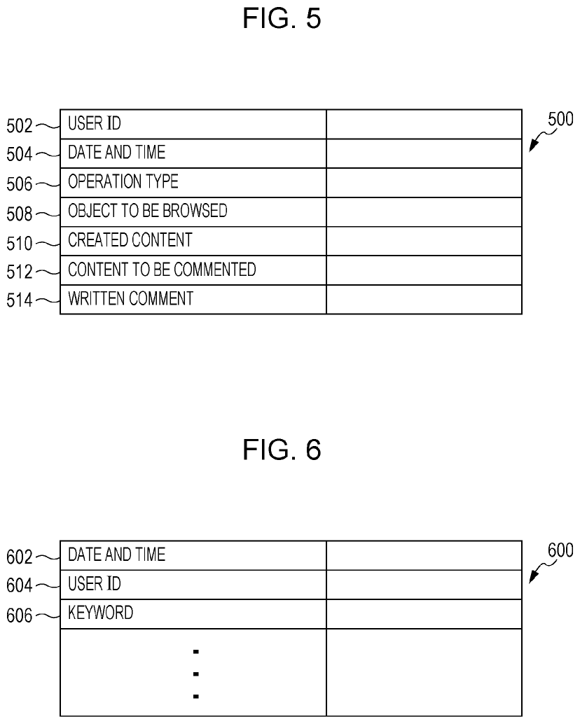

In step S304, step S306, step S308, collection may be made from log information of the target relevant individual. For instance, a log information table 500 is used. FIG. 5 is an explanatory table illustrating a data structure example of the log information table 500. The log information table 500 has a user ID column 502, a data and time column 504, an operation type column 506, an object to be browsed column 508, a created content column 510, a content to be commented column 512, and a written comment column 514. The user ID column 502 stores a user ID. The user here is relevant individual to the user 210, and corresponds to the user 230A and the user 230B illustrated in the example of FIG. 2. The data and time column 504 stores the data and time (the interpretation of the “date and time” may be year, month, date, time, minute, second, sub-second and a combination thereof) on which the user performed an operation. The operation type column 506 stores the type of operation performed by the user, and corresponds to, for instance, browsing of content, creation of a document, and writing of a comment. The object to be browsed column 508 stores the content browsed by the user or the storage location (specifically, such as a URL) of the content. The created content column 510 stores the content created by the user. The content to be commented column 512 stores the content on which a comment is written by the user. The written comment column 514 stores the comments written by the user.

In step S310, a keyword is extracted. A keyword is extracted from the content, comments collected in step S304, step S306, and step S308. A keyword may be extracted using morphological analysis or the like in language processing. For instance, a feature of a document may be extracted as a keyword. A feature of a document indicates a characteristic of the document, and in general, refers to a word (a morpheme such as a single word). In addition, information on sentence, parse may be included. In order to construct a morphological (word) vector for document clustering, a vector space model is used in general. As a characteristic of a document, data is represented by an n-dimensional vector with each dimension corresponding to a word which appears in a document set. Selecting words to construct a vector is called morphological selection. All the information contained in a document is not necessarily useful, thus effective morphemes are selected. The morphological selection is widely presented and utilized in the field of document classification. If all words are processed with the same weight, it is not possible to perform effective morphological selection. Some words appear only in a specific field, other words appear in almost any field. For instance, when the weight of the former words is set high and the weight of the latter words is set low, the positional relationship between vectors can be made closer to the positional relationship between actual data. For weighting words, tf-idf is used in general. Tf (abbreviation of Term Frequency) is the number of appearances of a word in a document. Idf (abbreviation of Inverse Document Frequency) is the reciprocal of how often a word appears in all documents. Although tf is calculated for each document, idf is calculated for each word. The product tf-idf of these two values may be used.

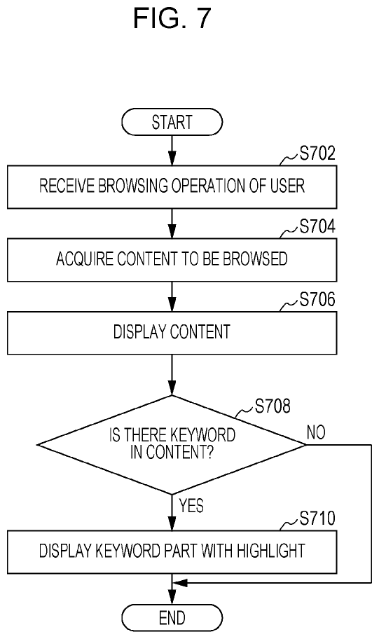

As a result of the processing in step S310, for instance, a keyword table 600 is created. FIG. 6 is an explanatory table illustrating a data structure example of the keyword table 600. The keyword table 600 has a date and time column 602, a user ID column 604, and a keyword column 606. The date and time column 602 stores the date and time on which the processing in step S310 is performed. The user ID column 604 stores a user ID. The keyword column 606 stores a keyword extracted from the content, and the comments in relation to the user. In other words, the keyword table 600 manages a keyword for each relevant individual.

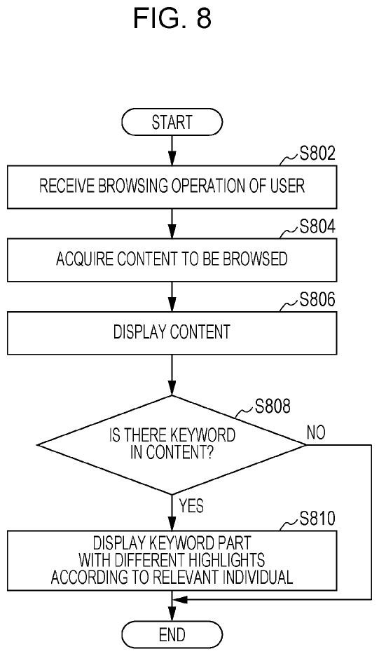

FIG. 7 is a flowchart illustrating an example of processing according to the exemplary embodiment.

In step S702, a browsing operation of the user 210 is received. The browsing operation corresponds to, for instance, an operation of selecting content which the user 210 wants to browse from a content group retrieved by a retrieval operation of the user 210.

In step S704, content to be browsed is acquired.

In step S706, the content is displayed.

In step S708, it is determined whether or not a keyword is present in the content. When a keyword is present, the flow proceeds to step S710, otherwise the processing ends (step S799). Specifically, it is sufficient to determine whether or not the keyword (specifically, the keyword in the keyword column 606) in the keyword table 600 is found in the content presented.

In step S710, keyword portions are displayed in highlight. For instance, the characters in the keyword portions are changed to larger characters, the color is changed to a color (for instance, gray) different from that of other characters, or the keyword portions are underlined. When the keyword portions are outputted as sound, only the portions may have loud sound, or before and after the output of sound for the portions, sound or music may be outputted.

In addition, not only the keyword portions, but also the sentences containing the keyword portions may be displayed with highlight, or a keyword similar to the keyword may also be displayed with highlight.

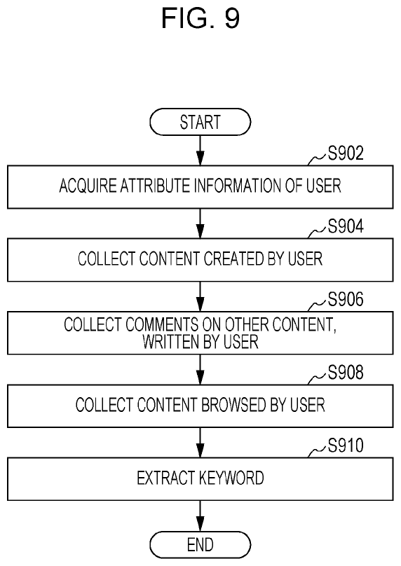

FIG. 8 is a flowchart illustrating an example of processing according to the exemplary embodiment. In the example illustrated in FIG. 7, the keyword portions are uniformly displayed with highlight. The user 210 may have multiple relevant individuals, and the type of display with highlight may be differentiated according to a relevant individual. In other words, each keyword portion may allow the browsing user to tell which one of the relevant individuals of the user 210 considers the keyword portion to be important.

In step S802, a browsing operation of the user 210 is received.

In step S804, content to be browsed is acquired.

In step S806, the content is displayed.

In step S808, it is determined whether or not a keyword is present in the content. When a keyword is present, the flow proceeds to step S810, otherwise the processing ends (step S899).

In step S810, the keyword portions are displayed with differentiated highlight according to a relevant individual. Specifically, since the user ID column 604 and the keyword column 606 of the keyword table 600 correspond to each other, when the keyword of the keyword column 606 is displayed with highlight, the keyword is highlighted according to the corresponding user ID of the user ID column 604. For instance, the keyword is highlighted in red for user X, and the keyword is highlighted in blue for user Y.

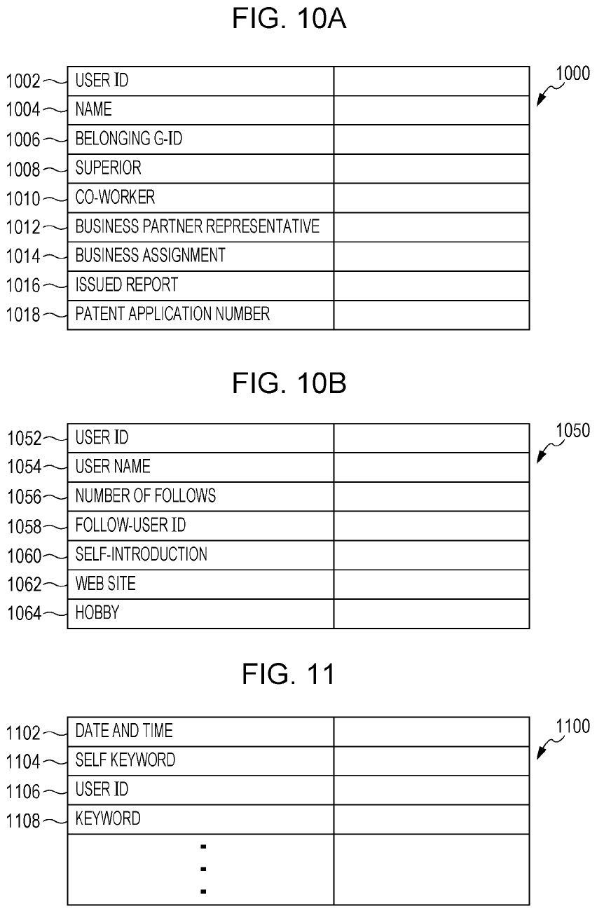

FIG. 9 is a flowchart illustrating an example of processing according to the exemplary embodiment. In the example of flowchart illustrated in FIG. 3, a keyword is extracted from the content, comments of a relevant individual of the user 210. However, a keyword may be extracted from the content, comments of the user 210 himself/herself.

In step S902, the attribute acquisition module 105 acquires the attribute information of the user 210.

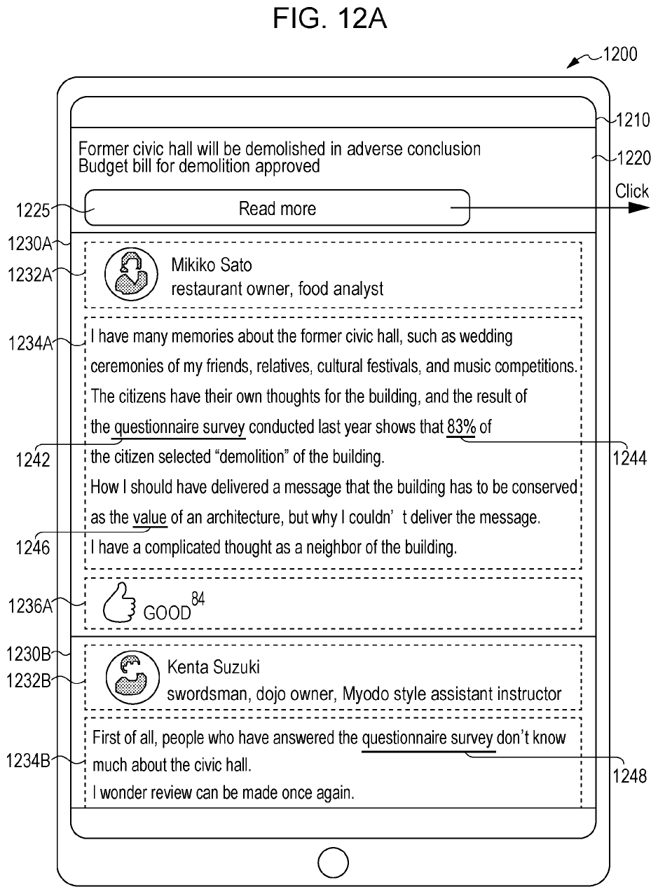

For instance, when the user 210 attempts to browse content at work, a user attribute (work) table 1000 is acquired. FIG. 10A is an explanatory table illustrating a data structure example of the user attribute (work) table 1000. The user attribute (work) table 1000 has a user ID column 1002, a name column 1004, a belonging G-ID column 1006, a superior column 1008, a co-worker column 1010, a business partner representative column 1012, a business in charge column 1014, an issued report column 1016, and a patent application number column 1018. The user attribute (work) table 1000 is obtained by adding the business in charge column 1014, the issued report column 1016, and the patent application number column 1018 to the user attribute (work) table 400. The user ID column 1002 stores a user ID. The name column 1004 stores the name of the user. The belonging G-ID column 1006 stores the group ID of the group to which the user belongs. The superior column 1008 stores the user ID of a superior of the user. The co-worker column 1010 store the user ID of a co-worker of the user. The business partner representative column 1012 stores the user ID of a business partner representative of the user. The business in charge column 1014 stores the business in charge of the user. The issued report column 1016 stores the issued reports of the user. The patent application number column 1018 stores the patent application numbers of the user recorded as the inventor.

When the user 210 attempts to browse content based on a personal interest other than work, a user attribute (SNS) table 1050 is acquired. FIG. 10B is an explanatory table illustrating a data structure example of the user attribute (SNS) table 1050. The user attribute (SNS) table 1050 has a user ID column 1052, a user name column 1054, a number of follows column 1056, a follow-user ID column 1058, a self-introduction column 1060, a Web site column 1062, and a hobby column 1064. The user attribute (SNS) table 1050 is obtained by adding the self-introduction column 1060, the Web site column 1062, and the hobby column 1064 to the user attribute (SNS) table 450. The user ID column 1052 stores a user ID. The user name column 1054 stores the user name of the user. The number of follows column 1056 stores the number of follows in an SNS followed by the user. The follow-user ID 1058 stores the user ID of another user followed by the user. The self-introduction column 1060 stores self-introduction of the user. The Web site column 1062 stores the Web site owned by the user. The hobby column 1064 stores the hobbies of the user.

In step S904, the content created by the user 210 is collected.

In step S906, the comments written by the user 210 on other content are collected.

In step S908, the content browsed by the user 210 is collected.

In step S910, a keyword is extracted. A keyword is extracted from the content, comments collected in step S904, step S906, and step S908. It is to be noted that a keyword may be extracted from the attribute information itself. For instance, a keyword may be extracted from the business in charge column 1014 of the user attribute (work) table 1000, and the self-introduction column 1060, the hobby column 1064 of the user attribute (SNS) table 1050.

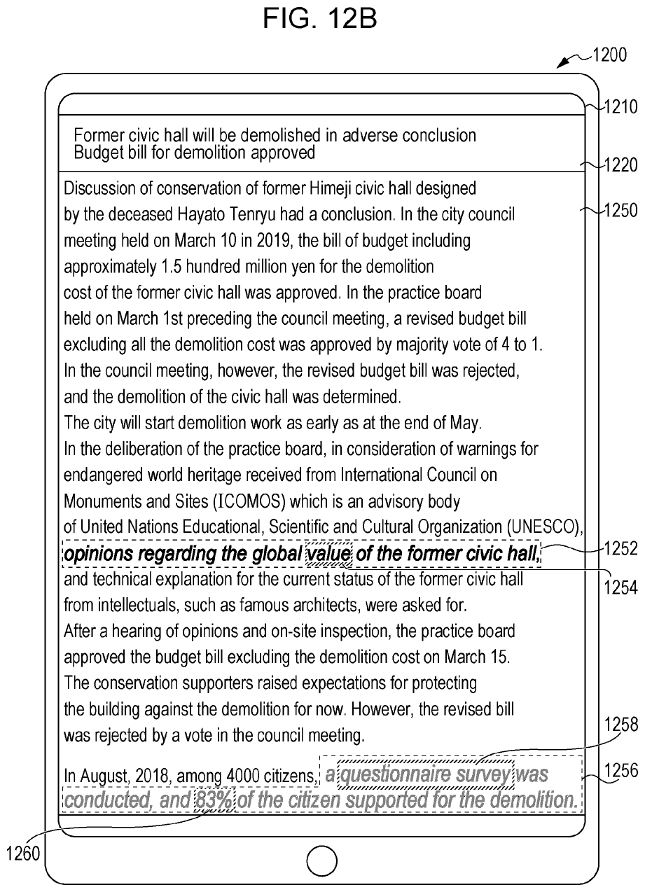

As a result of the processing in step S910, for instance, a keyword table 1100 is created. FIG. 11 is an explanatory table illustrating a data structure example of the keyword table 1100. The keyword table 1100 has a date and time column 1102, a self-keyword column 1104, a user ID column 1106, and a keyword column 1108. The keyword table 1100 is obtained by adding the self-keyword column 1104 to the keyword table 600. The date and time column 1102 stores the date and time on which the processing in step S910 is performed. The self-keyword column 1104 stores keywords in relation to the user himself/herself. The user ID column 1106 stores a user ID. The keyword column 1108 stores keywords extracted from the content, comments in relation to the user.

As in the example of flowchart illustrated in FIG. 8, when highlighted display is performed, the keyword portions in relation to the user may be displayed with highlight differently from the keyword portions in relation to other users. Particularly when the keyword portions in relation to the user and the keyword portions in relation to other users are overlapped, further different highlighted display may be performed. For instance, characters may be displayed in gray and a larger font size may be used for the characters.

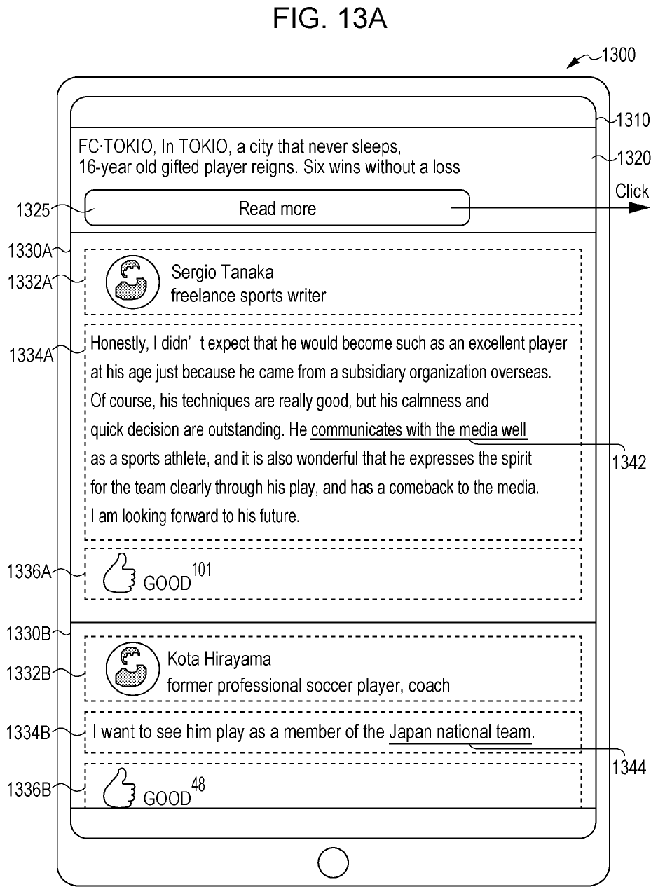

FIGS. 12A and 12B are explanatory screens illustrating an example of processing according to the exemplary embodiment.

As illustrated in the example of FIG. 12A, a user terminal 1200 has a screen 1210.

The screen 1210 displays a news title display area 1220, a “read more” bottom 1225, a posted data display area 1230A, and a posted data display area 1230B.

The posted data display area 1230A displays a commentator (followed by the user) display area 1232A, a posted content display area 1234A, and a “Good” display area 1236A.

The posted data display area 1230B displays a commentator (followed by the user) display area 1232B, and a posted content display area 1234B. When an upward scroll operation is performed, posted data (such as a comment) of a person followed by the user is displayed. The posted data is listed in descending order of the count of “Good”. The posted data may be for a news currently displayed. In this case, a keyword gaining attention in the news is extracted from the posted data display area 1230.

The information processing device 100 is incorporated in the user terminal 1200, or the SNS server 250 having the functions of the information processing device 100 is accessed, and a news is displayed.

The news title display area 1220 displays “Former civic hall will be demolished in adverse conclusion. Budget bill for demolition approved”.

The commentator (followed by the user) display area 1232A displays “Mikiko Sato, restaurant owner, food analyst”, the posted content display area 1234A displays “I have many memories about the former civic hall, such as wedding ceremonies of my friends, relatives, cultural festivals, and music competitions. The citizens have their own thoughts for the building, and the result of the questionnaire survey conducted last year shows that 83% of the citizen selected “demolition” of the building. How I should have delivered a message that the building has to be conserved as the value of an architecture, but why I couldn't deliver the message. I have a complicated thought as a neighbor of the building”, and the “Good” display area 1236A displays a “Good” mark and the number “84” of selections of “Good”.

The commentator display area 1232B displays “Kenta Suzuki swordsman, Dojo owner, Myodo style assistant instructor”, and the posted content display area 1234B displays “First of all, people who have answered the questionnaire survey don't know much about the civic hall. I wonder review can be made once again”.

In the state illustrated in the example of FIG. 12A, the “read more” button 1225 is selected by the user, and the text of the news article is displayed, which is shown in the example of FIG. 12B.

The screen 1210 displays the news title display area 1220, and a news article text display area 1250.

The news title display area 1220 displays “Former civic hall will be demolished in adverse conclusion. Budget bill for demolition approved”, and the news article text display area 1250 displays “Discussion of conservation of former Himeji civic hall designed by the deceased Hayato Tenryu had a conclusion. In the city council meeting held on Mar. 10, 2019, the bill of budget including approximately 1.5 hundred million yen for the demolition cost of the former civic hall was approved. In the practice board held on March 1st preceding the council meeting, a revised budget bill excluding all the demolition cost was approved by majority vote of 4 to 1. In the council meeting, however, the revised budget bill was rejected, and the demolition of the civic hall was determined. The city will start demolition work as early as at the end of May. In the deliberation of the practice board, in consideration of warnings for endangered world heritage received from International Council on Monuments and Sites (ICOMOS) which is an advisory body of United Nations Educational, Scientific and Cultural Organization (UNESCO), opinions regarding the global value of the former civic hall, and technical explanation for the current status of the former civic hall from intellectuals, such as famous architects, were asked for. After a hearing of opinions and on-site inspection, the practice board approved the budget bill excluding the demolition cost on March 15. The conservation supporters raised expectations for protecting the building against the demolition for now. However, the revised bill was rejected by a vote in the council meeting. In August, 2018, among 4000 citizens, a questionnaire survey was conducted, and 83% of the citizen supported for the demolition”.

In the text of the news article, a keyword “value” 1254 is displayed with highlight such as italic, a larger font size, and hatching in the background, and a keyword sentence 1252 containing the keyword “value” 1254 is displayed with highlight in italic, and a larger font size. This corresponds to a keyword “value” 1246 in the posted content display area 1234A.

A keyword “questionnaire survey” 1258, a keyword “83%” 1260, are displayed with highlight such as gray characters, italic, a larger font size, and hatching in the background, and a keyword sentence 1253 containing the keyword “questionnaire survey” 1258, the keyword “83%” 1260 is displayed with highlight in gray characters, italic, and a larger font size. This corresponds to a keyword “questionnaire survey” 1242, a keyword “83%” 1244 in the posted content display area 1234A, and a keyword “questionnaire survey” 1248 in the posted content display area 1234B.

The font of a word and a sentence cited by a commentator followed by the user is changed. The size of characters may be larger for a greater number of citations. Gray characters may be used for a greater number of negative comments. A word cited by a commentator with many counts of “Good” may be highlighted by hatching.

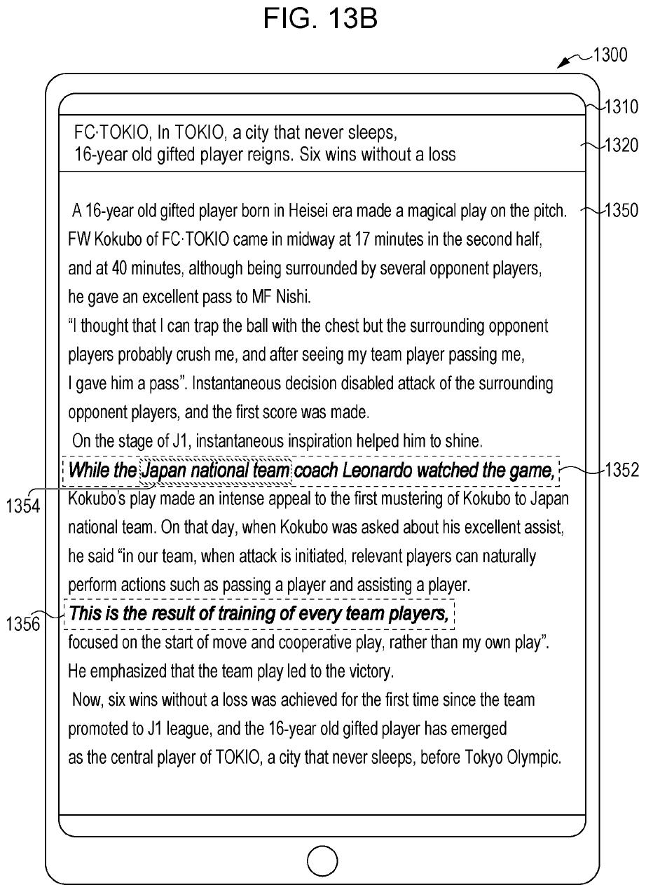

FIGS. 13A and 13B are explanatory screens illustrating an example of processing according to the exemplary embodiment.

As illustrated in the example of FIG. 13A, a user terminal 1300 has a screen 1310.

The screen 1310 displays a news title display area 1320, a “read more” button 1325, a posted data display area 1330A, and a posted data display area 1330B.

The posted data display area 1330A displays a commentator (followed by the user) display area 1332A, a posted data display area 1334A, and a “Good” display area 1336A.

The posted data display area 1330B displays a commentator (followed by the user) display area 1332B, a posted content display area 1334B, and a “Good” display area 1336B. When an upward scroll operation is performed, posted data (such as a comment) of a person followed by the user is displayed. The posted data is listed in descending order of the count of “Good”. The posted data may be for a news currently displayed. In this case, a keyword gaining attention in the news is extracted from the posted data display area 1330.

The information processing device 100 is incorporated in the user terminal 1300, or the SNS server 250 having the functions of the information processing device 100 is accessed, and a news is displayed.

The news title display area 1320 displays “FC⋅TOKIO, in TOKIO, a city that never sleeps, 16-year old gifted player reigns. Six wins without a loss”.

The commentator (followed by the user) display area 1332A displays “Sergio Tanaka, freelance sports writer”, the posted data display area 1334A display “Honestly, I didn't expect that he would become such as an excellent player at his age just because he came from a subsidiary organization overseas. Of course, his techniques are really good, but his calmness and quick decision are outstanding. He communicates with the media well as a sports athlete, and it is also wonderful that he expresses the spirit for the team clearly through his play, and has a comeback to the media. I am looking forward to his future”, and the “Good” display area 1336A displays a “Good” mark and the number “101” of selections of “Good”.

The commentator (followed by the user) display area 1332B displays “Kota Hirayama, former professional soccer player, coach”, the posted data display area 1334A display “I want to see him play as a member of the japan national team”, and the “Good” display area 1336B displays a “Good” mark and the number “48” of selections of “Good”.

In the state illustrated in the example of FIG. 13A, the “read more” button 1325 is selected by the user, and the text of the news article is displayed, which is shown in the example of FIG. 13B.

The user terminal 1300 has the screen 1310.

The screen 1310 displays the news title display area 1320, and a news article text display area 1350.

The news title display area 1320 displays “FC⋅TOKIO, in TOKIO, a city that never sleeps, 16-year old gifted player reigns. Six wins without a loss”, and the news article text display area 1350 displays “A 16-year old gifted player born in Heisei era made a magical play on the pitch. FW Kokubo of FC⋅TOKIO came in midway at 17 minutes in the second half, and at 40 minutes, although being surrounded by several opponent players, he gave an excellent pass to MF Nishi. “I thought that I can trap the ball with the chest but the surrounding opponent players probably crush me, and after seeing my team player passing me, I gave him a pass”. Instantaneous decision disabled attack of the surrounding opponent players, and the first score was made. On the stage of J1, instantaneous inspiration helped him to shine. While the Japan national team coach Leonardo watched the game, Kokubo's play made an intense appeal to the first mustering of Kokubo to Japan national team. on that day, when Kokubo was asked about his excellent assist, he said “In our team, when attack is initiated, relevant players can naturally perform actions such as passing a player and assisting a player. This is the result of training of every team players, focused on the start of move and cooperative play, rather than my own play”. He emphasized that the team play led to the victory. Now, six wins without a loss was achieved for the first time since the team promoted to J1 league, and the 16-year old gifted player has emerged as the central player of TOKIO, a city that never sleeps, before Tokyo Olympic”.

In the text of the news article, a keyword “Japan national team” 1354 is displayed with highlight such as italic, a larger font size, and hatching in the background, and a keyword sentence 1352 containing the keyword “Japan national team” 1354 is displayed with highlight in italic, and a larger font size. This corresponds to a keyword “Japan national team” 1344 in the posted content display area 1334B.

In addition, a keyword sentence 1356 is displayed with highlight such as gray characters, italic, and a larger font size. This is because the keyword sentence contains a keyword in a posted message by a commentator for the news title display area 1320.

The font of a word and a sentence cited by a commentator followed by the user is changed. The size of characters may be larger for a greater number of citations. Gray characters may be used for a greater number of positive comments. A word cited by a commentator with many counts of “Good” may be highlighted by hatching.

It is to be noted that in order to determine whether a comment is positive or negative, positive terms and negative terms are stored in advance, the number of positive terms and the number of negative terms out of the terms used is a target comment are counted, and the positiveness or negativeness of the entire comment may be determined.

In the examples of FIGS. 12A and 12B, FIGS. 13A and 13B, the case where a news article is browsed is shown. However, a document used at work may be browsed. For instance, content to be browsed may be meeting minutes. In this case, statement part of a superior of the browsing user may be displayed with highlight. Specifically, a superior of the browsing user is extracted from the superior column 408 of the user attribute (work) table 400, the name of the superior is retrieved from the meeting minutes, sentences before and after the name may be displayed with highlight. Alternatively, language processing such as morphological analysis is performed, statement part (for instance, when the superior is Mr. A, “Mr. A stated that . . . ” is statement part) of the superior is extracted, and the statement part may be displayed with highlight.

When meeting minutes are generated as text using speech recognition technology, a larger font size may be used for a statement spoken loudly by the superior, a character string may be arranged diagonally right up or diagonally right down according to the intonation of the statement by the superior, or the space between characters may be changed according to the speed of the statement spoken by the superior. It is to be noted that when speech recognition is performed, speakers, loudness of each voice, intonation of statements, and speed of statements may be embedded in meeting minutes as the attributes, and may be utilized for changing the contents of the character strings in the meeting minutes.

It is to be noted that the hardware configuration of a computer which executes the program as the exemplary embodiment is that of a general-purpose computer, specifically, a personal computer, and a computer which can operate as a server. In other words, as a specific example, CPU 1401 is used as the processing unit (arithmetic unit), and RAM 1402, ROM 1403, and HDD 1404 are used as storage devices. For instance, HDD (abbreviation of Hard Disk Drive), and SSD (abbreviation of Solid State Drive) which is a flash memory may be used as the HDD 1404. The hardware configuration includes the CPU 1401 that executes programs such as the attribute acquisition module 105, the follow-user information collection module 110 the content acquisition module 115, the content style change module 120, and the presentation module 125; the RAM 1402 that stores the programs and data; the ROM 1403 that stores a program for starting the computer; the HDD 1404 that serves as an auxiliary storage device and stores the user attribute (work) table 400, the user attribute (SNS) table 450, the log information table 500, the keyword table 600, the user attribute (work) table 1000, the user attribute (SNS) table 1050, the keyword table 1100, and content; a receiving device 1406 that receives data based on an operation (including action, voice, line of sight) of the browsing user performed on a keyboard, a mouse, a touch screen, a microphone, and a camera (including a line of sight detection camera); an output device 1405 such as a CRT, a liquid display, and a loudspeaker; a communication line interface 1407, such as a network interface card, for connecting to a communication network; and a bus 1408 for connecting the above-mentioned components and exchanging data. Multiple computers, each of which is the above-described computer, may be coupled to each other via a network.

For a computer program in the above-described exemplary embodiment, the computer program serving as software is read into a system having the hardware configuration, and software and hardware resources work together to implement the exemplary embodiment described above.

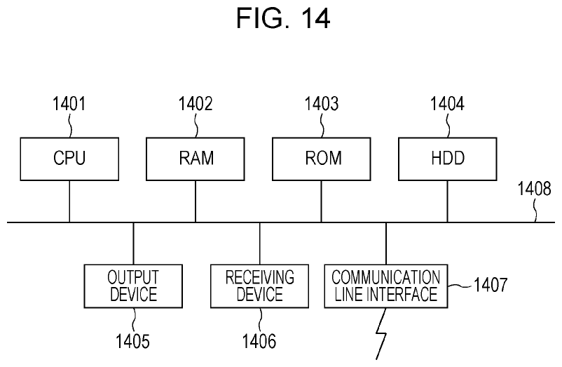

It is to be noted that the hardware configuration illustrated in FIG. 14 only shows a configuration example, the exemplary embodiment is not limited to the configuration illustrated in FIG. 14, and may have a configuration which allows the modules described in the exemplary embodiment to be executed. For instance, part of the modules may be formed by dedicated hardware (for instance, Application Specific Integrated Circuit (ASIC)), or field-programmable gate array (FPGA), part of the modules may reside in an external system and connected via a communication line, and multiple systems, each of which is the system illustrated in FIG. 14, may be connected to each other via a communication line to work together in a cooperative manner. In particular, in addition to a personal computer, a mobile information communication device (including a mobile phone, a smartphone, a mobile device, and a wearable computer), home information appliances, a robot, a copier, a facsimile, a scanner, a printer, a multifunctional device (an image processing device having at least two of the functions of a scanner, a printer, a copier, and a facsimile) may include the modules incorporated therein.

In the examples described above, a text is primarily used as the content. However, content such as an image and a video may be used. For instance, an image and/or a video may be changed in real time. Specifically, in a video, secondary audio may be added.

Content may be personalized according to the preference of an individual. The preference may be determined using attributes, action history, and sensing data.

It is to be noted that the program described above may be stored in a recording medium and provided, or the program may be provided by a communication unit. In this case, for instance, the above-described program may be regarded as the disclosure of a “computer readable recording medium on which the program is recorded”.

The “computer readable recording medium on which the program is recorded” refers to a computer readable recording medium on which the program is recorded, used for install, execution, and distribution of the program.

It is to be noted that the recording medium includes, for instance, “DVD-R, DVD-RW, DVD-RAM” which are digital versatile discs (DVD) and standards developed by DVD Forum, “DVD+R, DVD+RW” which are standards developed by DVD+RW, a read only memory (CD-ROM), a CD recordable (CD-R), and a CD rewritable (CD-RW) which are compact discs (CD), a Blu-ray (registered trademark) disc, a magneto-optical disc (MO), a flexible disc (FD), a magnetic tape, a hard disc, a read only memory (ROM), an electrically erasable programmable read-only memory (EEPROM (registered trademark)), a flash memory, a random access memory (RAM), an SD (abbreviation of Secure Digital) memory card.

All or part of the program may be recorded on the recording medium and stored or distributed. Alternatively, all or part of the program may be transmitted by communication using, for instance, a wired network, a wireless communication network, and a communication medium as a combination thereof which are used for a local area network (LAN), a metropolitan area network (MAN), a wide area network (WAN), an internet, an intranet, and an extranet. Alternatively, all or part of the program may be transmitted on a carrier wave.

In addition, the program may be part or all of another program, or may be recorded on a recording medium along with a separate program. Alternatively, the program may be divided and recorded on multiple recording media. The program may be recorded in a compressed or encrypted format as long as the program can be restored.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising
a change unit that changes details of content browsed by a browsing user according to information on an individual other than the browsing user of the content.

2. The information processing device according to claim 1, wherein the individual other than the browsing user is selected using attribute information which indicates attributes of the browsing user.

3. The information processing device according to claim 1, wherein the change unit changes a format of the content.

4. The information processing device according to claim 2, wherein the attribute information indicates an individual followed by the browsing user.

5. The information processing device according to claim 4, wherein the information on the individual other than the browsing user is information of all or part of details of content disclosed by the individual followed by the browsing user or all or part of details of content disclosed in relation to the individual.

6. The information processing device according to claim 5, wherein the change unit changes a word in content requested by the browsing user, the word being same as or similar to a word in the content disclosed by the individual.

7. The information processing device according to claim 2, wherein the content is meeting minutes, the attribute information indicates an organization to which the browsing user belongs, and the information on the individual other than the browsing user indicates a person having relation to the browsing user in the organization.

8. The information processing device according to claim 7, wherein the change unit makes a change on part of a statement in the meeting minutes, the statement being made by the person having relation to the browsing user.

9. A non-transitory computer readable medium storing an information processing program causing a computer to execute a process comprising
changing details of content browsed by a browsing user according to information on an individual other than the browsing user of the content.

10. An information processing device comprising
change means for changing details of content browsed by a browsing user according to information on an individual other than the browsing user of the content.
